(19) United States
(12) Patent Application Publication
(10) Pub. No.: US 2023/0080055 A1
(43) Pub. Date: Mar. 16, 2023

(54) SYSTEM AND METHOD FOR PRODUCT PLACEMENT

(71) Applicant: UNEFI INC., Toronto (CA)

(72) Inventors: Samuel Arthur Vise, Toronto (CA); Ranko Dimic, Toronto (CA)

(21) Appl. No.: 17/799,427

(22) PCT Filed: Mar. 18, 2021
(86) PCT No.: PCT/CA2021/050359

§ 371 Date: Aug. 12, 2022

Related U.S. Application Data
(60) Provisional application No. 62/992,563, filed on Mar. 20, 2020.

(51) Int. Cl. G06Q 30/06; G06Q 30/02; G06V 20/52

(52) U.S. Cl. CPC G06Q 30/0603; G06Q 30/0204; G06V 20/52

(57) ABSTRACT

Systems and methods relating to product placement and for generating metrics relating to product placement. A plurality of cameras is deployed at a retail establishment and the output from these cameras is analyzed to track customers inside the retail establishment. Data from a database containing product data, product location data, and purchase data generated from point of sales terminals at the retail establishment is correlated with the time stamped and time indexed footage and images from the various cameras. Analysis of these various data sets provides indications as to who is in the store, who purchases products, what products are purchased, when were products purchased, what promotions were running in the store, and where were these products located in the retail establishment.

### TECHNICAL FIELD

The present invention relates to product placement. More specifically, the present invention relates to systems and methods for managing product placement in retail establishments.

### BACKGROUND

The telecommunications and data processing revolution of the early 21st century has brought data processing into almost every aspect of modern life. This includes retail establishments as data mining and data analytics allow for the massive amounts of retail data being generated to predict and process our purchasing decisions.

One area that such analytics has not been properly applied to is retail establishment management. While some retail establishments can record, track, and gather data about what we buy at such places, such analytics are sorely lacking in terms of what is purchased. Currently, heat maps, customer tracking, and even loyalty programs are used to determine locations in a retail establishment where customers congregate, linger, browse or purchase. However, such methods do not allow retailers to determine details about who is lingering (e.g., male, female and age range), who is actually buying, and what products are they purchasing from the retail establishment. Not only that, but none of these methods allow retailers to track what products are purchased by which demographic group and at what time. In addition, none of these methods allow retailers to determine which locations in a retail establishment generate the most product sales.

Based on the above, there is therefore a need for systems and methods that allow for analytics to be applied to not just customer demographics but also to product placement and product location in a retail establishment.

### SUMMARY

The present invention provides systems and methods relating to product placement and for generating metrics relating to product placement. A plurality of cameras is deployed at a retail establishment and the output from these cameras is analyzed to track customers inside the retail establishment. Data from a database containing product data, product location data, and purchase data generated from point of sales terminals at the retail establishment is correlated with the time stamped and time indexed footage and images from the various cameras. Analysis of these various data sets provides indications as to who is in the store, who purchases products, what products are purchased, when were products purchased, what promotions were running in the store, and where were these products located in the retail establishment.

In a first aspect, the present invention provides a system for managing placement of items in a retail establishment, the system comprising:
a plurality of cameras for capturing images of customers in said retail establishment;
a database storing:
   identification of marketing materials in said retail establishment;
   product identification numbers for said products;
   purchase data for said retail establishment detailing time of purchase and product identification numbers for products purchased by customers at said retail establishment; and
   item location data detailing a location in said retail establishment for a plurality of products identified by said product identification numbers and for said marketing materials in said retail establishment;
      wherein
output from said plurality of cameras is analyzed and correlated with contents of said database to determine an effectiveness of placement of said marketing materials and of said products in said retail establishment;
said output from said plurality of cameras is analyzed to determine demographic data for said customers;
at least one of said plurality of cameras is placed to capture images of customers entering said retail establishment;
at least one of said plurality of cameras is placed to capture images of customers purchasing products at said retail establishment.

In a second aspect, the present invention provides a method for managing item placement in a retail establishment, the method comprising:
a) receiving an output of a plurality of cameras, at least one of said plurality of cameras being placed to capture images of customers entering said retail establishment, and at least one of said plurality of cameras being placed to capture images of customers purchasing products at said retail establishment;
b) accessing a database containing:
   identification of marketing materials in said retail establishment;
   product identification numbers for said products;
   purchase data for said retail establishment detailing time of purchase and product identification numbers for products purchased by customers at said retail establishment; and
   item location data detailing a location in said retail establishment for a plurality of products identified by said product identification numbers and for said marketing materials in said retail establishment;
c) analyzing and correlating said output from said plurality of cameras with contents of said database to determine an effectiveness of placement of items in said retail establishment; and
d) analyzing said output from said plurality of cameras to determine demographic data for a plurality of said customers.

### BRIEF DESCRIPTION OF THE DRAWINGS

The embodiments of the present invention will now be described by reference to the following figures, in which identical reference numerals in different figures indicate identical elements and in which:

FIG. 1 is a block diagram illustrating one aspect of the present invention; and

FIG. 2 is a block diagram illustrating the steps in a method according to another aspect of the present invention.

### DETAILED DESCRIPTION

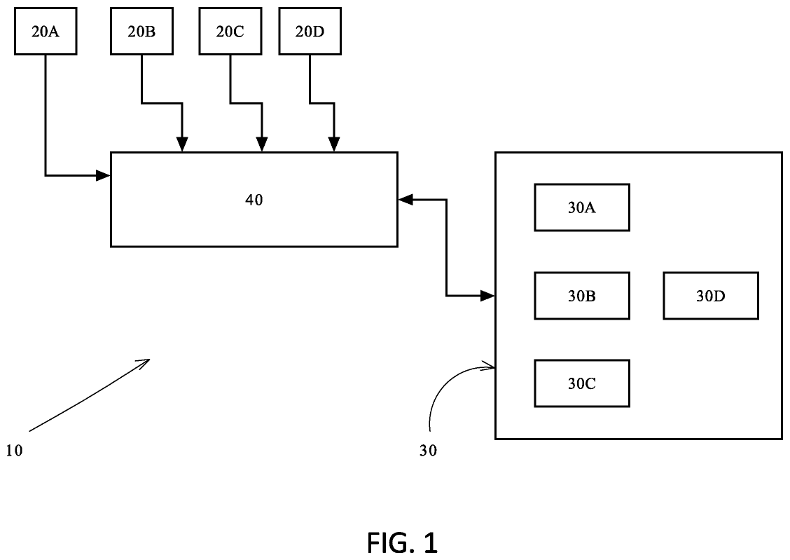

Referring to FIG. 1, a block diagram of a system according to one aspect of the invention is illustrated. The system 10 includes a number of cameras 20A, 20B, 20C, 20D, a database 30, and an analysis module 40. The database 30 includes purchase data 30A, item location data 30B, product identification numbers 30C, and an identification of marketing materials 30D. Purchase data 30A includes data generated from a POS (point of sale) terminal such as time and date of purchases, products purchased, purchase totals, the SKU (stock keeping unit) numbers of the products purchased, the quantity of products purchased, and/or the product identification numbers of the products purchased. Item location data 30B includes the SKU and/or product identification number of each product for sale at a retail establishment as well as the specific location of that product in that retail establishment. Item location data also includes the location of marketing material present/in use in the retail establishment. The location for each product and/or marketing material may include not just a zone/area in the retail establishment but also the specific fixture (e.g. a specific display case) where the product/marketing material is located, and even the specific shelf and placement on that shelf for the product. The product identification numbers 30C detail the identification number (which may be specific to the store/business) for each product for sale at the retail establishment. Marketing material identification 30D may include the identification of any marketing material (e.g. flyers, leaflets, marketing signage, promotional videos playing on monitors, audio commercials playing over speakers, static and dynamic displays of products and/or services on offer, display/promotional devices either in storage or on display at the retail establishment, etc., etc.) on display/in storage at the retail establishment. As noted above, the location of such marketing material is detailed by the item location data in the database. The marketing material identification 30D may detail the number (quantity) and type of marketing material available/in use as well as any fixtures necessary to use the marketing material (e.g. a stand for static printed displays, a monitor for video presentations, etc., etc.), the various promotions/marketing campaigns applicable to the marketing material, the physical size/parameters for the marketing material, size requirements for the marketing material, and any other relevant and/or necessary data regarding that marketing material. The identification of marketing material 30D may also include, in some implementations, the existing/current marketing/promotional campaign(s) being run within the retail establishment.

The analysis module 40 may be a combination hardware/software module that receives the output of the various cameras 20A-20D and analyzes this output. This analysis may be combined with the various contents of the database to produce data usable by a user.

In operation, at least one of the cameras 20A-20D is placed to enable image capture of the area adjacent to or at the point of sale (POS) terminal(s). This allows for the at least one camera to capture images of the customers executing transactions at the POS terminal. As well, it is preferred that at least one other camera is placed/located such that images can be captured of customers entering the retail establishment. It is also preferred that at least one other camera be placed/located such that images of customers leaving the retail establishment can be captured.

The system works by capturing images of customers entering the retail establishment, tracking each customer throughout the retail establishment, and determining what each customer has purchased. Further analysis methods can then be used on the data generated to determine where the purchased products were originally located in the retail establishment prior to their purchase and, accordingly, which areas/placement of products are most effective. Tracking customers is accomplished by tagging each customer entering the retail establishment—the image of each customer entering the retail establishment is analyzed to determine identifying characteristics to build a unique or semi-unique profile for that customer. Demographic data such as ethnicity and age range and characteristics such as each customer's clothing and the color of the clothing can be used to identify/track each customer while that customer is inside the retail establishment. As the customer wanders the retail establishment, he or she is tracked using the various cameras or the images captured by the cameras. It should be clear that specific metadata (e.g. the identifying characteristics, demographic data, etc., etc.) for each customer is generated based on the image captured for that customer. Once the customer is at a point of sale terminal, the cameras directed at the terminal capture the metadata about the customer as he or she purchases products from the retail establishment. This purchase generates purchase data that is then stored in the database. This metadata of the customer purchasing can then be correlated with the generated purchase data in the database to determine what was purchased. If necessary, a record of what products were purchased, the distinguishing characteristics of the customer purchasing the products (e.g. the customer demographics such as age range and ethnicity), the time and date of the purchase, and other relevant details about the products purchased can be created. The generated records can then be analyzed for ends such as effectiveness of the marketing materials (e.g. marketing signage) and/or product placement within the retail establishment as well as the retail establishment's over all profile such as clientele, busy hours, and popular products. The generated records may also be analyzed to determine the effectiveness of the placement/use of the various marketing materials/marketing signage within the retail establishment. This can be done by correlating, over time, the purchase data in the database with the placement/location of the marketing materials.

Tracking customers in the retail establishment operates by creating a profile for each customer and storing that profile as someone who is still in the retail establishment. Once a camera directed at the exit captures an image corresponding to that profile, then that profile is removed from the list of those assumed to still be in the retail establishment. This list of profiles is correlated with the various images or footage captured by the various cameras to determine which customer is at which area of the retail establishment. For each set of footage from a camera, each customer in the footage is analyzed and a corresponding profile (which may be a set of metadata) in the list is assigned to that customer (i.e. the profile that best corresponds to the customer is assigned to that customer). This way, the location of each customer is known/can be known while that customer is in the retail establishment.

It should be clear that each customer is tagged with a unique or semi-unique profile as noted above. This profile is used for each specific customer throughout the various sets of footage or images captured by the different cameras. As an example, an entrance camera directed at the entrance to the retail establishment captures the image of a specific customer A. Analysis of the image indicates that customer A is male, approximately 25-30 years old and is of Asian ethnicity. These data points determined by analysis of the footage or image forms the basis for a specific profile for customer A. The profile is then saved with profiles of other customers who are known to still be in the retail establishment (i.e. the exit camera directed at the exit has not captured an image of a customer corresponding to a given profile known to be in the retail establishment—once the exit camera detects an image of a specific customer on the list of profiles of customers known to be in the retail establishment, that profile is removed from the list). A corner camera, directed at one corner of the retail establishment, captures the image of a customer entering the frame. Analysis of that image indicates that the customer in the image is male, approximately 30-35 years old, and is of Asian ethnicity. Assuming that no other profile in the list of profiles of customers in the retail establishment matches the analysis, then the profile for customer A is assigned to this customer. It should be clear that even if the analysis indicates a less than perfect match between the results of the customer image analysis and one of the profiles in the list of known customers still in the retail establishment, the profile that best matches the customer image analysis is assigned to that customer. As should be clear, once the exit camera detects an image of a customer whose analysis results is closest to the profile for customer A, then the profile for customer A is removed from the list of customers known to be in the retail establishment.

As another example, the POS camera (i.e., the camera directed at the point of sale terminal) captures the images of customers at the POS. Analysis of the images of the customers at the POS is correlated with the list of profiles of customers known to be in the retail establishment and one of these profiles is selected for assignment to each of the customers in the images. The time stamp for each of the images captured by the POS camera is then correlated with purchase data in the database so that what was purchased at the time the image was taken can be determined. This step thus correlates the profile/demographic information for the purchasing customer with the purchasing data detailing what was purchased. Correlated data detailing the products purchased, the amount, the time of purchase, and the demographic information for the purchasing customer can then be stored separately. Since the purchase data includes the product identification numbers for the purchased products, these product identification numbers can be correlated with the product location data to create data points that include numbers of purchased products and locations in the retail establishment for these purchased products.

It should be clear that the system may be a near real-time system where images from the various cameras are transmitted to the analysis module for image analysis and for correlation with the various data in the database. Or, in another embodiment, the system may be configured so that the images from the various cameras are stored for later analysis (i.e. not real-time or near real-time). As well, the analysis module may be co-located as the cameras and/or the database or the analysis may be at another location to which the images are transmitted. It should be clear that the analysis module may be implemented using cloud computing or any other configuration that allows for multiple software and hardware subsystems to operate as the analysis module.

Given the amount and nature of the data generated by the system, analysis of the various data points can be used to create data reports that indicate which areas of the retail establishment are most lucrative, which product fixtures (e.g. which display shelves, which display cabinets) have sold the most products, and even which locations within those product fixtures are most effective in selling the displayed products. The data in the database can be analyzed, in conjunction with the images from the various cameras and the data generated by the POS, to provide reports on one or more of the following:
SKUs sold per retail establishment;
SKUs sold per given amount of time;
SKUs sold per zone in the retail establishment;
Sales per fixture;
Sales per fixture type;
Sales per fixture location;
Sales per retail establishment fixture count;
Sales per SKU count;
current promotional material deployed at the retail establishment;
past promotional material previously deployed at the retail establishment;
current marketing materials deployed at the retail establishment (e.g., marketing signage deployed); and
current and/or past marketing devices used or in use at the retail establishment.

In addition to the above data reports, the system may be used to generate profiles for the various customers to determine a profile for the majority of the retail establishment's customers. In addition, the time stamps for the various footages and images from the various cameras can also be used to determine traffic patterns, time patterns, and customer visit patterns for the retail establishment. More importantly, the purchasing behavior of the retail establishment's customers can be modeled/extrapolated from the data gathered from the footage/images and the data in the database. This modeling can be used to determine what products are being purchased, the quantity of the products being purchased, when are the products being purchased, and who (or what is the demographic profile) is the customer purchasing the products. The modeling can be used to also determine these data points for a specific period of time (e.g. during a specific marketing campaign or while a specific marketing signage promotion period is ongoing/operative).

The data generated can also be analyzed to not only determine customer behavior but also to determine retail establishment metrics. In one implementation, instances of the system of the present invention are deployed across multiple retail establishments and analytics for each retail establishment's performances can be generated. Metrics for multiple retail establishments can be combined to arrive at multiple reports including sales volume per fixture location per retail establishment.

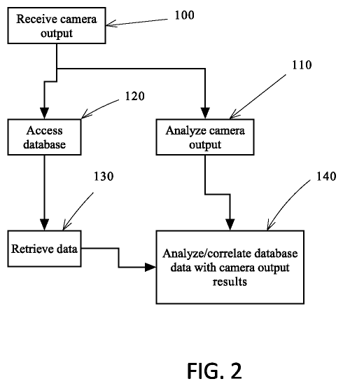

Referring to FIG. 2, the steps in a method according to one aspect of the present invention is illustrated. As can be seen, the method begins at step 100, that of receiving the output of one or more cameras in a retail establishment. Step 110 is that of analyzing the output of the cameras to determine demographic data/metadata for the customers in the images from the cameras. Step 120 is then that of accessing a database that contains data relating to products, fixtures, marketing material, sales, etc., etc. as detailed above. This data is then retrieved in step 130 and then analyzed and correlated with the demographic data/metadata for the camera output (step 140). This analysis/correlation allows for reports that detail the effectiveness of the product placement, marketing material placement, and other factors relative to customer demographics. It should be clear that the camera output analysis may proceed in parallel with the database access/retrieval.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for managing placement of items in a retail establishment, the system comprising:
a plurality of cameras for capturing images of customers in said retail establishment;
a database storing:
identification of marketing materials in said retail establishment;
product identification numbers for said products;
purchase data for said retail establishment detailing time of purchase and product identification numbers for products purchased by customers at said retail establishment; and
item location data detailing a location in said retail establishment for a plurality of products identified by said product identification numbers and for said marketing materials in said retail establishment;
wherein
output from said plurality of cameras is analyzed and correlated with contents of said database to determine an effectiveness of placement of said marketing materials and of said products in said retail establishment;
said output from said plurality of cameras is analyzed to determine demographic data for said customers;
at least one of said plurality of cameras is placed to capture images of customers entering said retail establishment;
at least one of said plurality of cameras is placed to capture images of customers purchasing products at said retail establishment.

2. The system according to claim 1, further comprising an analysis module for receiving said output from said plurality of cameras and for analyzing said output.

3. The system according to claim 1, wherein said output of said plurality of cameras is transmitted to a physically remote analysis module that analyzes said output to determine said demographic data for said customers.

4. The system according to claim 1, wherein said output of said plurality of cameras is correlated with said purchase data to determine demographic data for customers purchasing products from said retail establishment.

5. The system according to claim 1, wherein said purchase data is correlated with said item location data and said product identification numbers to determine locations in said retail establishment where purchased products were located.

6. The system according to claim 5, wherein effectiveness of product locations in said retail establishment is determined by how many products located at each location were purchased by customers.

7. The system according to claim 1, wherein said output of said plurality of cameras is analyzed to determine how many customers purchased products from said retail establishment.

8. The system according to claim 1, wherein said output of said plurality of cameras is analyzed to enable tracking of at least one of said customers through said demographic data determined for said at least one of said customers.

9. The system according to claim 8, wherein said output of said plurality of cameras is correlated with said purchase data and said demographics of said at least one of said customers to determine which customer has purchased which products from said retail establishment.

10. The system according to claim 1, wherein said output of said plurality of cameras is correlated with said purchase data and contents of said database to determine an effectiveness of marketing material placement in said retail establishment.

11. A method for managing item placement in a retail establishment, the method comprising:
a) receiving an output of a plurality of cameras, at least one of said plurality of cameras being placed to capture images of customers entering said retail establishment, and at least one of said plurality of cameras being placed to capture images of customers purchasing products at said retail establishment;
b) accessing a database containing:
identification of marketing materials in said retail establishment;
product identification numbers for said products;
purchase data for said retail establishment detailing time of purchase and product identification numbers for products purchased by customers at said retail establishment; and
item location data detailing a location in said retail establishment for a plurality of products identified by said product identification numbers and for said marketing materials in said retail establishment;
c) analyzing and correlating said output from said plurality of cameras with contents of said database to determine an effectiveness of placement of items in said retail establishment; and
d) analyzing said output from said plurality of cameras to determine demographic data for a plurality of said customers.

12. The method according to claim 11, further comprising using said demographic data to label and track customers in said retail establishment.

13. The method according to claim 11, further comprising correlating demographic data and an output of said at least one of said plurality of cameras placed to capture images of customers purchasing products at said retail establishment to determine which customers have purchased products at said retail establishment.

14. The method according to claim 11, further comprising correlating said purchase data and an output of said at least one of said plurality of cameras placed to capture images of customers purchasing products at said retail establishment to determine which customers have purchased products at said retail establishment.

15. The method according to claim 11, further comprising correlating said purchase data and an output of said at least one of said plurality of cameras placed to capture images of customers purchasing products at said retail establishment to determine which products have been purchased by which customers at said retail establishment.

16. The method according to claim 11, further comprising correlating said purchase data, said item location data, and an output of said at least one of said plurality of cameras placed to capture images of customers purchasing products at said retail establishment to determine locations in said retail establishment where purchased products were located.

17. The method according to claim 11, further comprising correlating said purchase data, said demographic data, and an output of said at least one of said plurality of cameras placed to capture images of customers purchasing products at said retail establishment to determine demographics of customers purchasing specific products.

18. The method according to claim 11, further comprising correlating said purchase data and a time index of an output of said at least one of said plurality of cameras placed to capture images of customers purchasing products at said retail establishment to determine which customers have purchased products at said retail establishment.

19. The method according to claim 11, further comprising correlating said purchase data and a time index of an output of said at least one of said plurality of cameras placed to capture images of customers purchasing products at said retail establishment to determine which products were purchased by which customers at said retail establishment.

20. The method according to claim 11 further comprising correlating said purchase data and contents of said database to determine an effectiveness of marketing material placement in said retail establishment.
